(19) United States
(12) Patent Application Publication
(10) Pub. No.: US 2015/0341848 A1
(43) Pub. Date: Nov. 26, 2015

(54) METHOD AND APPARATUS FOR DISCOVERING RADIO NETWORK

(71) Applicant: ELECTRONICS AND TELECOMMUNICATIONS RESEARCH INSTITUTE, Daejeon (KR)

(72) Inventors: Jae Su SONG, Daejeon (KR); Yunhee CHO, Daejeon (KR); Seung-Hwan LEE, Daejeon (KR)

(73) Assignee: ELECTRONICS AND TELECOMMUNICATIONS RESEARCH INSTITUTE, Daejeon (KR)

(21) Appl. No.: 14/626,949

(22) Filed: Feb. 20, 2015

(30) Foreign Application Priority Data
May 26, 2014 (KR) 10-2014-0063289

(51) Int. Cl. H04W 48/16

(52) U.S. Cl. CPC H04W 48/16

(57) ABSTRACT

A terminal determines a state of the terminal among an idle state and a connected state. The terminal selects one of a plurality of network scan methods based on a state of the terminal. In addition, the terminal discovers an accessible radio network according to the selected scan method.

### CROSS-REFERENCE TO RELATED APPLICATION

This application claims priority to and the benefit of Korean Patent Application No. 10-2014-0063289 filed in the Korean Intellectual Property Office on May 26, 2014, the entire contents of which are incorporated herein by reference.

### BACKGROUND OF THE INVENTION

1. (a) Field of the Invention

The present invention relates to a method for discovering a radio network, and an apparatus using the same.

2. (b) Description of the Related Art

Through the development of recent wireless communication systems, various radio access technologies (RATs) have appeared. This can be also obvious from prediction of the fifth generation (5G) system. As shown in FIG. 1, which shows the development direction of the radio network, the 5G system can be defined as a wireless communication system that includes a new RAT and various existing RATs. Thus, a user terminal is exposed to a communication environment where various radio networks or RATs are mixed.

Recently, the use of smart phones has rapidly increased. In terms of the wireless communication system, a multi-mode terminal that supports various RATs has been commonly used. Therefore, since a user terminal can access one or more radio networks at a specific moment, the user terminal has to select a radio network or RAT to access. However, before the user terminal chooses which radio network or RAT to access, the terminal should be aware of radio networks that the terminal can access at a current location. Conventionally, when the user needs to access a radio network, the user directly discovers a radio network or unconditionally accesses a network having a strong receiving signal. However, requirements such as universal access (UA) or always best connected (ABC) are generated for selection of a network that can support quality of experience (QoE) of the user to the maximum. Thus, a method for discovering a radio network that can satisfy such a requirement is required.

As a remedy for access to a radio network, a third generation (3G) partnership project (3GPP) defines a function node such as access network discovery and selection functions (ANDSF), and the IEEE (Institute of Electrical and Electronics Engineers) defines media independent services (MIS). Such a remedy enables a terminal to effectively perform discovery and selection of a radio network by providing information required for the discovery and selection from a network. However, although such a remedy is defined in a standard, different networks should cooperate and a protocol between a terminal and a network needs to be realized, and therefore such a remedy cannot be substantially realized and operated as a system in the short term.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for discovering a terminal accessible radio network and an apparatus using the same for selection of a radio network that can provide an optimal quality of experience (QoE).

According to an exemplary embodiment of the present invention, a method for a terminal to discover an accessible radio network is provided. The network discovering method includes: determining whether the terminal is in an idle state or a connected state; selecting at least one among a plurality of network scan methods based on the state of the terminal; and discovering an accessible radio network according to the selected scan method.

The selecting includes: when the terminal is in the connected state and thus is connected to a first radio network, selecting a first scan method that measures first information with respect to a second radio network while the terminal is not accessing the second radio network, among the plurality of network scan methods; and when the terminal is in the idle state, selecting a second scan method that measures the first information and second information which is performance information of the second radio network by accessing the second radio network, among the plurality of network scan methods.

The first information may be information measured in a case that a first interface for interfacing with the second radio network is being activated.

The second information may be quality of service (QoS) information of the second radio network measured through probe packet exchange between the terminal and a server in the second radio network.

The discovering the accessible radio network may include determining whether a discovery condition is satisfied when the second scan method is selected and discovering the second radio network according to the second scan method when the discovery condition is satisfied.

The discovery condition may include at least one of a first condition that a movement distance of the terminal after a first time at which the second radio network is discovered is greater than a first threshold value, a second condition that a lapse time from the first time is greater than a second threshold value, and a third condition that a movement speed of the terminal is lower than a third threshold value.

The discovering the second radio network according to the second scan method may include: activating the first interface; measuring the first information using the first interface; measuring the second information by accessing the second radio network based on the first information; and storing the first information and the second information.

The storing may include storing the first information and the second information together with terminal location information and time information in a database.

The first information may include a type of the second radio network, an identifier of the second radio network, a frequency of the second radio network, and receiving power of the second radio network.

The discovering of the accessible radio network may further include setting a timer for periodic radio network discovery.

The discovering of the accessible radio network may further include discovering the second radio network according to the first scan method when the first scan method is selected.

The discovering of the second radio network according to the first scan method may include activating the first interface, measuring the first information using the first interface, and acquiring the second information from the database using the first information.

The acquiring of the second information may include acquiring the second information from the data base using the terminal location information, a type of the second radio network, an identifier of the second radio network, and a frequency of the second radio network among the first information.

The network discovery method may further include selecting at least one of the accessible radio networks using the first information and the second information.

The discovering the second radio network according to the first scan method may further include acquiring quality of service (QoS) information of a third radio network which is a homogeneous network with the first radio network using the terminal location information from the database.

In addition, According to another exemplary embodiment of the present invention, a method for a terminal that supports a plurality of radio access technologies (RATs) to discover a radio network is provided. The network discovery method includes discovering a first radio network according to a first scan method among a plurality of network scan methods when the terminal is in an idle state.

The discovering the first radio network according to the first scan method may include: determining whether a discovery condition is satisfied; when the discovery condition is satisfied, measuring first information with respect to the first radio network through a first RAT interface that corresponds to the first radio network while not accessing the first radio network; and when the discovery condition is satisfied, measuring second information which is quality of service (QoS) information of the first radio network while accessing the first radio network.

The discovery condition may include at least one of a first condition that a movement distance of the terminal after a first time at which the terminal discovered the first radio network is greater than a first threshold value, a second condition that a lapse time from the first time is greater than a second threshold value, and a third condition that movement speed of the terminal is lower than a third threshold value.

The network discovery method may further include discovering the first radio network according to a second scan method among the plurality of network scan methods when the terminal is in a connected state and thus is connected to a second radio network.

The discovering the first radio network according to the first scan method may further include storing the first information and the second information in a database.

The discovering the first radio network according to the second scan method may include measuring the first information through the first RAT information while not accessing the first radio network and acquiring the second information using the first information from the database.

The second information may include a throughput of the first radio network, a packet loss rate of the first radio network, and a delay of the first radio network.

According to another exemplary embodiment of the present invention, a terminal that supports a plurality of RATs is provided. The terminal includes a memory and a processor connected with the memory and discovering a radio network.

The processor may select at least one among a plurality of network scan methods based on a state of the terminal and discovers an accessible radio network according to the selected scan method.

### BRIEF DESCRIPTION OF THE DRAWINGS

FIG. 1 illustrates a direction of development of a radio network.

FIG. 2 is a flowchart of the entire process for a terminal to search a radio network according to an exemplary embodiment of the present invention.

FIG. 3 is a flowchart of a process for the terminal to search a radio network according to a passive scan method according to the exemplary embodiment of the present invention.

FIG. 4 is a flowchart of a process for the terminal to search a radio network according to an active scan method according to the exemplary embodiment of the present invention.

FIG. 5 and FIG. 6 are flowcharts of a process for determining whether the terminal satisfies scan conditions and a process for searching a radio network according to whether the scan condition is satisfied according to the exemplary embodiment of the present invention.

FIG. 7 is a flowchart of a configuration of the terminal according to the exemplary embodiment of the present invention.

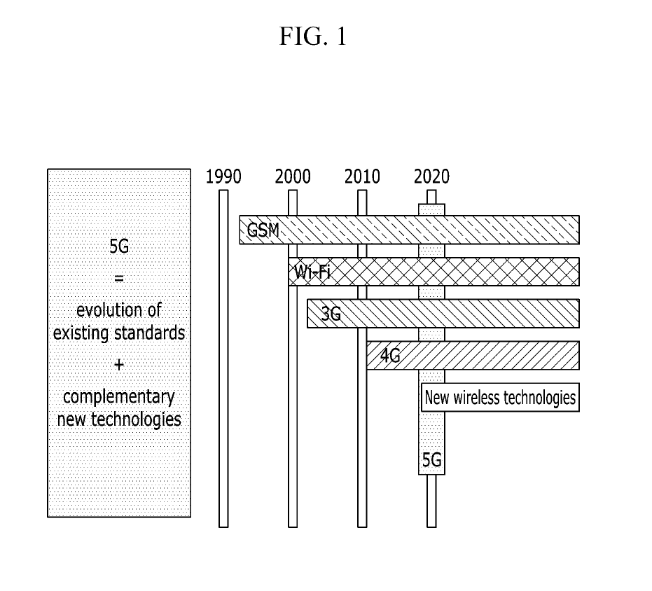

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, a terminal may represent a mobile terminal (MT), a mobile station (MS), an advanced mobile station (AMS), a high reliability mobile station (HR-MS), a subscriber station (SS), a portable subscriber station (PSS), an access terminal (AT), user equipment (UE), or the like, and may include all or some of the functions of the MT, the MS, the AMS, the HR-MS, the SS, the PSS, the AT, the UE, or the like.

In addition, a base station (BS) may represent an advanced base station (ABS), a high reliability base station (HR-BS), a node B, an evolved node B (eNodeB), an access point (AP), a radio access station (RAS), a base transceiver station (BTS), a mobile multi-hop relay (MMR)-BS, a relay station (RS) serving as a base station, a relay node (RN) serving as a base station, an advanced relay station (ARS) serving as a base station, a high reliability relay station (HR-RS) serving as a base station, a small base station [(femto BS), a home node B (HNB), a pico BS, a metro BS, a micro BS, or the like], or the like, and may include all or some of the functions of the ABS, the nodeB, the eNodeB, the AP, the RAS, the BTS, the MMR-BS, the RS, the RN, the ARS, the HR-RS, the small base station, or the like.

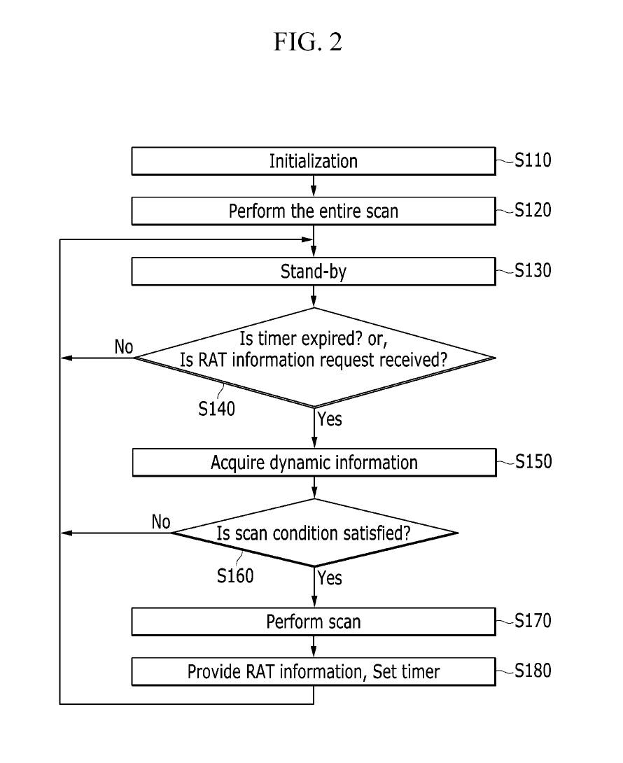

FIG. 2 is a flowchart of the entire process for a terminal to search a radio network according to an exemplary embodiment of the present invention. Hereinafter, for convenience of description, a cellular RAT (for example, 3 G) and a WiFi RAT that are most widely used among a plurality of RATs will be exemplarily illustrated. However, it is not restrictive, and the exemplary embodiment of the present invention may be applied to a typical multi-mode terminal that supports a plurality of RATs such as a cellular RAT, a WiFi RAT, and the like. Meanwhile, a terminal (e.g., a smart phone) may include a RAT interface for supporting multi-RAT, a device (e.g., a global positioning system, GPS) for measuring a location and speed of the terminal, and a memory (e.g., an information base) storing information generated according to performance of a radio network searching algorithm. Each RAT interfacing between a terminal and a radio network may correspond to at least one radio network.

A RAT discovery algorithm is basically performed in the background, and periodically performs RAT discovery or radio network discovery by a discovery request. In addition, the RAT discovery algorithm may store RAT information generated from the RAT discovery, or a device that requires RAT information may be provided. The device may be a RAT selector that selects at least one radio network among a plurality of radio networks using the RAT information. Referring to FIG. 2, the entire process of the RAT discovery algorithm will be described in detail.

When the RAT discovery algorithm is performed, the terminal performs an initialization operation for the RAT discovery algorithm (S110). In detail, the terminal may collect and store information required for performing the RAT discovery algorithm. The collected information may include static information and dynamic information. The static information may include information on the type of RAT interface that the terminal supports. The dynamic information may include a terminal location, a movement speed, and current time information.

When the initialization is finished, the terminal performs a scan operation with respect to all RATs that can be supported by the terminal. Here, the scan operation refers to operation for measuring the RAT information by turning on (or activating) the RAT interface. In detail, the scan operation refers to an operation in which the terminal activates a specific RAT interface and measures or acquires RAT information, which is information on a radio network that corresponds to the activated RAT interface. The RAT information is information on each radio network, and may include RAT detection information and RAT quality of service (QoS) information as shown in Table 1.

TABLE 1

| Classification | RAT detection information | RAT QoS information |
|---|---|---|
| Parameter | RAN ID (e.g., cellular: | QoS (e.g., throughput, |
| | cell ID, WiFi: SSID) | delay, packet loss rate) |
| | frequency (cellular: UARFCN, | |
| | WiFi: channel number), | |
| | receiving power | |

In detail, the RAT detection information is information on a radio network measured through an activated RAT interface. That is, the RAT detection information may be acquired from information received by a receiving unit of the terminal when the terminal turns on the RAT interface. The RAT detection information may include a radio access network (RAN) identifier (e.g., a cell ID for cellular RAT, a service set identifier (SSID) for WiFi RAT), a RAN frequency (e.g., an absolute ratio frequency channel number ARFCN for cellular RAT or universal mobile telecommunications system terrestrial radio access (ARFCN), a channel number for WiFi RAT), and receiving power of the RAN. The RAT QoS information is performance information of the corresponding network. In order to measure the performance information of the corresponding network, the terminal accesses a RAT (or a radio network) and exchanges a probe packet with a server in the corresponding network. The RAT QoS information may include a throughput, a packet loss rate, and a delay of the RAN.

When the step S120 is finished, the terminal stands by while waiting for a start signal for network discovery (S130). That is, the terminal waits for an event trigger. The start signal includes a signal (i.e., a time out signal) generated by a timer for the RAT discovery algorithm to perform a periodic scan operation, and a RAT information request signal generated by a RAT selector.

When such a start signal is generated (S140), the terminal acquires dynamic information (e.g., location and movement speed of the terminal and current time) for performing the RAT discovery algorithm from system information of the terminal (S150).

The terminal determines whether a scan condition is satisfied (S160). When receiving the start signal in the stand-by state, the terminal checks the scan condition and performs the scan operation if the scan condition is satisfied rather than directly performing the scan operation. Accordingly, power consumption from the RAT discovery algorithm performance of the terminal can be minimized. Meanwhile, the terminal selects at least one scan method among a plurality of scan methods (e.g., an active scan method and a passive scan method) according to a state (e.g., an idle state or a connected state) of the terminal, determines whether to measure a location of the terminal and simultaneous checks usability of a plurality of RAT interfaces, and performs network discovery according to the selected scan method. The terminal may determine a scan method to be substantially used by inspecting a scan condition.

When a scan method is determined, the terminal performs a scan operation according to the determined scan method (S170). The terminal stores a result of the step S170 (e.g., RAT information) in a database or reads required RAT information from the database.

When the RAT discovery algorithm performance is finished, the terminal provides the RAT information to a device (e.g., the RAT selector) that requires the RAT information, or may set the timer for the next RAT discovery (S180). After that, the terminal returns to the stand-by state and waits for a start signal.

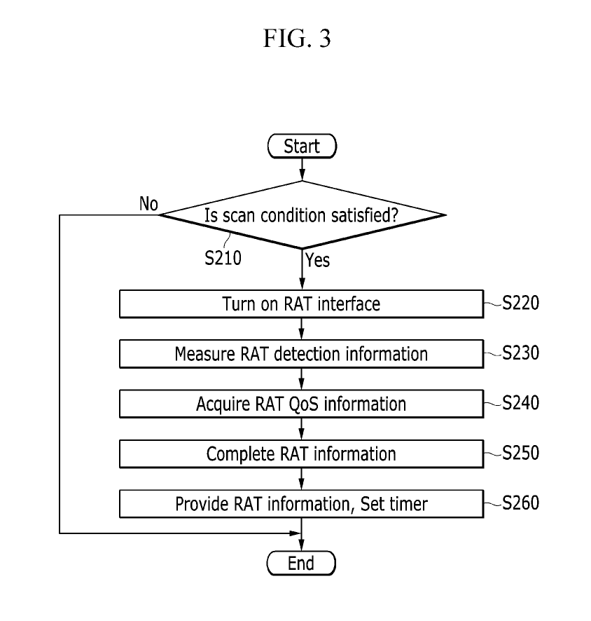

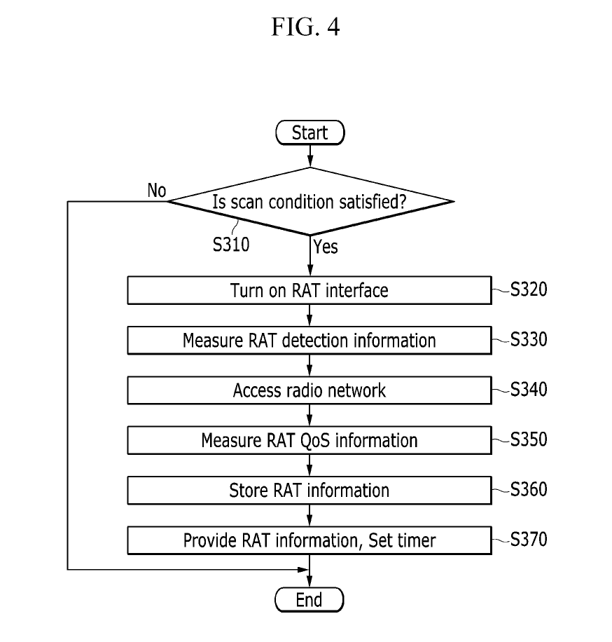

The scan method used by the terminal includes an active scan method and a passive scan method. In detail, when the terminal uses the passive scan method, the terminal turns on a RAT interface and measures or acquires RAT detection information from information received by a receiving unit of the terminal. When the terminal uses the passive scan method, the terminal measures only a receiving signal rather than directly accessing a RAT or a radio network, and therefore the passive scan method has a merit in fast performance speed and low power consumption. However, when the terminal uses the pass scan method, the terminal cannot access the RAT (or the radio network) so that the terminal cannot directly measure QoS information of the corresponding RAT (or the corresponding radio network). In addition, when the active scan method is used, the terminal turns on the RAT interface to measure the RAT detection information and accesses each RAT (or each radio network) to measure RAT QoS information of the corresponding RAT (or the corresponding radio network). The active scan method has a merit in acquisition of more precise information for selection of an optimal radio network because the terminal not only measures the RAT detection information but also measures RAT QoS information by substantially accessing the RAT (or the radio network). However, the active scan method has drawbacks in long term consumption and high power consumption for measurement of RAT detection information and RAT QoS information. In the exemplary embodiment of the present invention, the passive scan method and the active scan method are selectively used according to a condition of the terminal to acquire RAT information. A process for discovering a radio network according to the active scan method and a passive scan method will be described in detail with reference to FIG. 3 and FIG. 4.

FIG. 3 is a flowchart of a process for the terminal to discover a radio network according to the passive scan method according to the exemplary embodiment of the present invention.

The passive scan method can be used when the terminal cannot directly measure RAQ QoS information by accessing a specific RAT (or a radio network). In detail, the terminal acquires RAT detection information by measuring a signal received through the RAT interface. In addition, the terminal searches the database based on the RAT detection information, terminal location information, and time information. When RAT QoS information that matches a search value is found in the database, the terminal completes the RAT information using the searched RAT QoS information. If the terminal cannot turn on a specific RAT interface due to an operating system (OS) policy of the terminal, the terminal cannot measure RAT detection information corresponding to the RAT interface and therefore the terminal searches the database only with terminal location information and time information without RAT detection information. A detailed process of the radio network discovery according to the passive scan method (hereinafter referred to as passive discovery) is as follows.

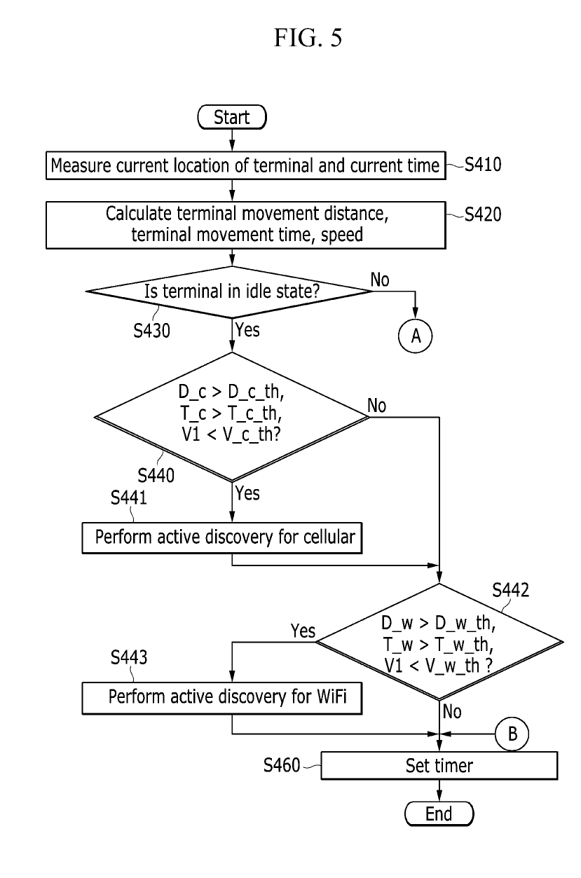

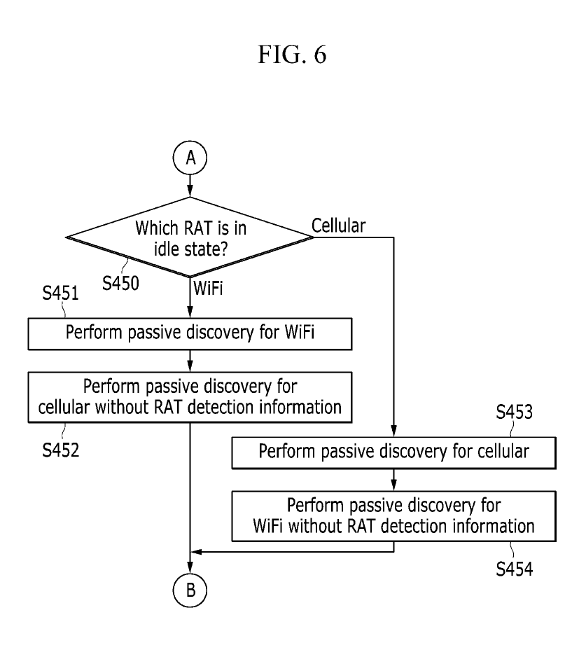

First, the, terminal determines whether the scan condition is satisfied (S210). In detail, the terminal can check whether the scan condition is satisfied based on a threshold value according to a characteristic of each RAT and location information of the terminal. The scan condition will be described in detail with reference to FIG. 5 and FIG. 6.

When the scan condition is satisfied, the terminal turns on the corresponding RAT interface if the RAT interface is in the turn-off state (S220).

The terminal measures RAT detection information through the turned-on RAT interface (S230). Here, the RAT detection information may include a RAN ID, receiving power, and a frequency with respect to a searched RAT (or a searched radio network).

The terminal searches RAT QoS information that has been measured in the past from the database using the measured RAT direction information, the terminal location information, and the time information (S240). In detail, the terminal can search RAT QoS information corresponding to current time information from the database. For example, when the current time is 14:00, the terminal can search information measured at about 14:00 among RAT QoS information that has been measured in the past.

When the RAT QoS information that matches the search value exists, the terminal completes the entire RAT information by querying the searched RAT QoS information (S250).

The terminal provides the complete RAT information to a device (e.g., the RAT selector) that requires the RAT information. In addition, the terminal may set the timer for determination of the next radio network discovery time (S260).

FIG. 4 is a flowchart of a process in which the terminal discovers a radio network using the active scan method according to the exemplary embodiment of the present invention.

The active scan method can be used when the terminal cannot directly measure RAT QoS information by accessing a radio network that corresponds to a RAT interface through the RAT interface. In detail, the terminal measures a receiving signal by turning on a specific RAT interface and acquires RAT detection information. In addition, the terminal measures RAT QoS information by accessing each of discovered RATs (or discovered radio networks) based on the RAT detection information. Then, the terminal stores the measured RAT QoS information in the database, together with the RAT detection information, terminal location information, and time information. The RAT information stored in the database can be used in the passive discovery. A detailed process of radio network discovery according to the active scan method (hereinafter, referred to as active discovery) is as follows.

First, the terminal determines whether a scan condition is satisfied (S310). In detail, the terminal can check whether the scan condition is satisfied based on a threshold value according to a characteristic of each RAT and location information of the terminal. The scan condition will be described in detail with reference to FIG. 5 and FIG. 6.

When the scan condition is satisfied, the terminal turns on the corresponding RAT interface of the RAT interface that is in the turn-off state (S320).

The terminal measures RAT detection information through the turned-on RAT interface (S330). Here, the RAT detection information may include a RAN ID, receiving power, and a frequency with respect to a searched RAT (or a searched radio network).

The terminal measures RAT QoS information by sequentially accessing RATs (or radio networks) according to information acquired from the RAT detection information (S340, S350).

The terminal stores the measured RAT QoS information in the database, together with the RAT detection information, the terminal location information, and the time information (i.e., current time information) (S360).

The terminal provides the complete RAT information to a device (e.g., the RAT selector) that requires the RAT information. In addition, the terminal may set the timer for determination of the next radio network discovery time (S370).

Exemplary embodiments of the RAT information stored in the database of the terminal are as shown in Table 2.

TABLE 2

| Classification | Category | Item | Note |
|---|---|---|---|
| Index | Location | longitude | Longitude |
| | information | latitude | Latitude |
| | Time | Time | Data, hour, minute, |
| | information | | second |
| | RAT | RAT type | numbering each |
| | detection | | RAT (e.g., Enum |
| | information | | (Cellular, WiFi)) |
| | | RAN ID | cellular RAT: Cell |
| | | | ID |
| | | | WiFi RAT: SSID |
| | | Frequency | cellular RAT: |
| | | (subchannel) | UARFCN or |
| | | | ARFCN |
| | | | WiFi RAT: |
| | | | channel number |
| Information | RAT detection | receiving power | [dBm] |
| | information | (Rx power) | |
| | RAT QoS | Throughput (or | [bps] |
| | information | information rate) | |
| | | Delay | [ms] |
| | | Packet loss rata | |

In detail, information corresponding to the index classification among the information stored in the database is data for determining whether information matches when information is searched (or read) from the database. The information corresponding to the index classification may include a current location of the terminal, current time, and a part (e.g., RAT type, RAN ID, a frequency) of the RAT detection information. The information corresponding to the index classification is a value that can be measured through the above-stated passive discovery. Meanwhile, information corresponding to the data classification among information stored in the database is substantially required information (i.e., desired information). The information corresponding to the data classification may include receiving power (Rx power) that can be measured through the passive discovery and the RAT QoS information that can be measured through the active discovery.

FIG. 5 and FIG. 6 are flowcharts illustrating a process for the terminal to determine whether the scan condition is satisfied and a process for radio network discovery according to whether the scan condition is satisfied.

Depending on a state of the terminal, radio network discovery performance is changed. In detail, when the terminal is in an idle state, a user is not using a communication service, and therefore the radio network discovery process does not interrupt a user's service. Therefore, the terminal in the idle state can perform the active discovery. However, power consumption may occur due to iterative performance of the discovery process. Therefore, the discovery process should be performed a minimum number of times only when the network discovery is necessary.

When the terminal is in the connected state and thus the terminal is connected to a radio network, a user is using a communication service so that the radio network discovery process may interrupt the service use of the user. Therefore, the terminal should quickly perform the network discovery process. In addition, when the terminal is using a specific RAT interface, the terminal cannot perform a scan operation through the corresponding RAT interface. Thus, when the terminal is in the connected state, the terminal should perform the passive discovery. Due to such a reason, in the exemplary embodiment of the present invention, the terminal in the idle state measures a location, speed, and time of the terminal, and performs the active discovery with respect to each RAT (or each radio network) only when the measured value (location, speed, time, and the like) satisfies the scan condition.

Meanwhile, the scan condition can be defined as follows. The scan condition may include a first condition, a second condition, and a third condition. When movement distances D_c and D_w of the terminal after the previous discovery process is performed are greater than threshold values D_c_th and D_w_th, the first condition is satisfied. When lapse times T_c and T_w from after the previous discovery process is performed are greater than threshold values T_c_th and T_w_th, the second condition is satisfied. When movement speed V1 of the terminal is lower than threshold values V_c_th and V_w_th, the third condition is satisfied. In FIG. 5, for convenience of description, the scan condition requires satisfaction of the first to third conditions, but this is not restrictive. The scan condition may be defined to a case in which at least one of the first to third conditions is satisfied. In FIG. 5, variables and threshold values used in the scan condition are as shown in Table 3.

TABLE 3

| Variable | Definition | Note | |
|---|---|---|---|
| V1 | Movement speed of terminal | $V 1 = \frac{\vert P\_m \_o - P\_m \_n \vert}{T\_poll}$ | |
| P_m_o | Past location of terminal | Previous location where RAT | |
| | | discovery is performed | |
| P_m_n | Current location of terminal | | |
| T_m_o | Past time of terminal | Previous time that RAT | |
| | | discovery is performed | |
| T_m_n | Current time of terminal | | |
| P_c_o | Previous RAT discovery | | |
| | location with respect | | |
| | to cellular RAT | | |
| D_c | Movement distance of RAT | D_c = \|P_c_o − P_m_n\| | |
| | discovery with respect to | | |
| | cellular RA T(movement | | |
| | distance of terminal) | | |
| T_c | Lapse time of RAT discovery | T_c = \|T_c_o − T_m_n\| | |
| | with respect to cellular RAT | | |
| T_c_o | Time of previous RAT | | |
| | discovery with respect | | |
| | to cellular RAT | | |
| P_w_o | Previous RAT discovery | | |
| | location with respect to | | |
| | WiFi RAT | | |
| D_w | Movement distance of RAT | D_w = \|P_w_o − P_m_n\| | |
| | discovery with respect to | | |
| | WiFi RAT (movement | | |
| | distance of terminal) | | |
| T_w | Lapse time of RAT discovery | T_w = \|T_w_o − T_m_n\| | |
| | with respect to WiFi RAT | | |
| T_w_o | Time of previous RAT | | |
| | discovery with respect to | | |
| | WiFi RAT | | |
| T_poll | Timer value for periodical | 60 | [s] |
| | RAT discovery operation | | |
| D_c_th | Movement distance threshold | 1000 | [m] |
| | value of cellular RAT | | |
| T_c_th | Movement time threshold | 180 | [s] |
| | value of cellular RAT | | |
| V_c_th | Movement speed threshold | 10 | [m/s] |
| | value of cellular RAT | | |
| D_w_th | Movement distance threshold | 30 | [m] |
| | value of WiFi RAT | | |
| T_w_th | Movement time threshold | 60 | [s] |
| | value of WiFi RAT | | |
| V_w_th | Movement speed threshold | 3 | [m/s] |
| | value of WiFi RAT | | |

A process in which the terminal determines whether the scan condition is satisfied and performs radio network discovery according to a result of the determination will now be described in detail.

First, the terminal measures a current location P_m_n and current time T_m_n (S410).

The terminal calculates the movement distances (D_c, D_w), movement times (T_c, T_w), and speed V1 of the terminal using previous discovery location information (P_c_o, P_w_o), previous discovery time information (T_c_o, T_w_o), current location information (P_m_n), and current time information (T_m_n) (S420). In detail, the terminal can calculate each of the movement distances (D_c, D_w), movement times (T_c, T_w), and the speed V1 of the terminal as given in Equation 1.

$$D\_c = \vert P\_c \_o - P\_m \_n \vert \\ D\_w = \vert P\_w \_o - P\_m \_n \vert \\ T\_c = \vert T\_c \_o - T\_m \_n \vert \\ T\_w = \vert T\_w \_o - T\_m \_n \vert \\ V 1 = \frac{\vert P\_m \_o - P\_m \_n \vert}{T\_poll} \qquad [ Equation 1 ]$$

The terminal determines a state of the terminal (S430). In detail, the terminal can determine whether the terminal is in the idle state or in the connected state. A case in which the terminal is in the connected state will be described in detail with reference to FIG. 6.

If the terminal is in the idle state, the terminal determines whether the scan condition is satisfied by comparing the movement distances (D_c, D_w), the movement times (T_c, T_w), and the speed V1 with the threshold values (D_c_th, D_w_th, T_c_th, T_w_th, V_c_th, V_w_th) (S440 and S442).

When the movement distance (D_c) of the terminal is greater than the threshold value (D_c_th) and the movement time (T_c) of the terminal is greater than the threshold value (T_c_th), and the terminal speed V1 is lower than the threshold value (V_c_th), the terminal performs the active discovery for a cellular RAT (or a cellular radio network) (S441).

When the movement distance (D_w) of the terminal is greater than the threshold value (D_w_th), the movement time (T_w) of the terminal is greater than the threshold value (T_w_th), and the terminal speed V1 is lower than the threshold value (V_w_th), the terminal performs the active discovery for a WiFi RAT (or a WiFi radio network) (S443).

The terminal may set a timer for determination of time for performing the next radio network discovery (S460).

FIG. 6 illustrates a process for the terminal in the connected state to discover a radio network. When the terminal is in the connected state, the terminal performs the passive discovery.

In detail, the terminal determines which RAT among the cellular RAT and the WiFi RAT is in the idle state (S450).

When the WiFi RAT interface is in the idle state and the cellular RAT interface is in use, the terminal performs the passive discovery with respect to the WiFi RAT (or the WiFi radio network) (S451). However, the terminal cannot measure RAT detection information on the cellular RAT interface that is in use, so the terminal performs the passive discovery using the current location information (P_m_n) and the current time information (T_m_n) with respect to the cellular RAT (or the cellular radio network) without using the RAT detection information. Here, the passive discovery may be searching RAT QoS information from the database using the current location information (P_m_n) and the current time information (T_m_n) without using the RAT detection information (S452).

When the cellular RAT interface is in the idle state and the WiFi RAT interface is in use, the terminal performs the passive discovery with respect to the cellular RAT (or the cellular radio network) (S453). However, since the terminal cannot measure RAT detection information with respect to the WiFi RAT interface that is in use, the terminal performs the passive discovery with respect to the WiFi RAT (or the WiFi radio network) using the current location information (P_m_n) and the current time information (T_m_n) without using the RAT detection information (S454).

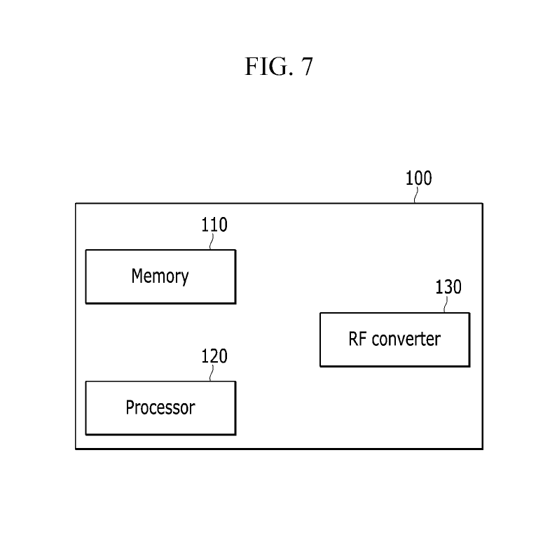

FIG. 7 illustrates a configuration of a terminal 100 according to the exemplary embodiment of the present invention.

The terminal 100 may include a memory 110, a processor 120, and a radio frequency (RF) converter 130.

The processor 120 may be formed to realize processes, methods, and functions related to the terminal described with reference to FIG. 2 to FIG. 6.

The memory 110 is connected with the processor 120 and stores various information related to operation of the processor 120.

The RF converter 130 is connected with the processor 120, and transmits or receives a radio signal. In addition, the terminal 100 may include a single antenna or multiple antennas.

The terminal 100 may measure or acquire RAT information through the radio network discovery described with reference to FIG. 2 to FIG. 6. The RAT information may be used to select a radio network (or a RAT) that can provide optimal quality of experience (QoE) to a user of the terminal 100. In detail, the terminal 100 discovers an accessible radio network (or a base station or RAT) by controlling several RAT interfaces, and selects an optimal radio network based on the discovered radio network. Therefore, according to the exemplary embodiment of the present invention, a new functional node or infrastructure may not need to be provided in the network, and definition of a new protocol may not be necessary.

The exemplary embodiments of the present invention relate to a method for discovering a base station that a terminal supporting multi-RAT interfaces can access in an environment where several heterogeneous networks are overlapped with each other. The exemplary embodiments of the present invention can provide RAT information required for selection of a radio network or RAT that can provide an optimal QoE to a terminal user.

According to the exemplary embodiments of the present invention, network discovery can be performed by autonomous operation of the terminal without additional network support. Therefore, according to the exemplary embodiments of the present invention, the exemplary embodiments can be realized in software, and thus the exemplary embodiments can be applied to a current wireless communication system merely through software installation in a smart phone that is currently in use. Accordingly, there is no need of additional implementation of a network infrastructure.

Further, according to the exemplary embodiments of the present invention, a terminal can perform radio network discovery and selection without being provided with network information so that power consumption can be reduced. In detail, according to the exemplary embodiments of the present invention, the network discovery can be performed using at least one of an active discovery method and a passive discovery method according to a state of the terminal so that power consumption of the terminal in an idle state can be reduced.

In addition, according to the exemplary embodiments of the present invention, the radio network discovery process can be performed without interrupting user service of the terminal in a connected state.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for a terminal to discover an accessible radio network, comprising:
determining whether the terminal is in an idle state or a connected state;
selecting at least one among a plurality of network scan methods based on the state of the terminal; and
discovering an accessible radio network according to the selected scan method.

2. The method of claim 1, wherein the selecting comprises:
when the terminal is in the connected state and thus is connected to a first radio network, selecting a first scan method that measures first information with respect to a second radio network while the terminal is not accessing the second radio network, among the plurality of network scan methods; and
when the terminal is in the idle state, selecting a second scan method that measures the first information and second information which is performance information of the second radio network by accessing the second radio network, among the plurality of network scan methods.

3. The method of claim 2, wherein the first information is information measured in a case that a first interface for interfacing with the second radio network is being activated, and the second information is quality of service (QoS) information of the second radio network measured through probe packet exchange between the terminal and a server in the second radio network.

4. The method of claim 3, wherein the discovering the accessible radio network comprises:
determining whether a discovery condition is satisfied when the second scan method is selected; and
discovering the second radio network according to the second scan method when the discovery condition is satisfied, and
the discovery condition comprises at least one of a first condition that a movement distance of the terminal after a first time at which the second radio network is discovered is greater than a first threshold value, a second condition that a lapse time from the first time is greater than a second threshold value, and a third condition that a movement speed of the terminal is lower than a third threshold value.

5. The method of claim 4, wherein the discovering of the second radio network according to the second scan method comprises:
activating the first interface;
measuring the first information using the first interface;
measuring the second information by accessing the second radio network based on the first information; and
storing the first information and the second information.

6. The method of claim 5, wherein the storing comprises storing the first information and the second information together with terminal location information and time information in a database, and
the first information comprises a type of the second radio network, an identifier of the second radio network, a frequency of the second radio network, and receiving power of the second radio network.

7. The method of claim 6, wherein the discovering the accessible radio network further comprises setting a timer for periodic radio network discovery.

8. The method of claim 6, wherein the discovering of the accessible radio network further comprises discovering the second radio network according to the first scan method when the first scan method is selected, and
the discovering of the second radio network according to the first scan method comprises
activating the first interface,
measuring the first information using the first interface, and
acquiring the second information from the database using the first information.

9. The method of claim 8, wherein the acquiring of the second information comprises acquiring the second information from the database using the terminal location information, a type of the second radio network, an identifier of the second radio network, and a frequency of the second radio network among the first information.

10. The method of claim 9, further comprising selecting at least one of the accessible radio networks using the first information and the second information.

11. The method of claim 8, wherein the discovering of the second radio network according to the first scan method further comprises acquiring quality of service (QoS) information of a third radio network which is a homogeneous network with the first radio network using the terminal location information from the database.

12. A method for a terminal that supports a plurality of radio access technologies (RATs) to discover a radio network, comprising
discovering a first radio network according to a first scan method among a plurality of network scan methods when the terminal is in an idle state,
wherein the discovering of the first radio network according to the first scan method comprises:
determining whether a discovery condition is satisfied;
when the discovery condition is satisfied, measuring first information with respect to the first radio network through a first RAT interface that corresponds to the first radio network while not accessing the first radio network; and
when the discovery condition is satisfied, measuring second information which is quality of service (QoS) information of the first radio network, while accessing the first radio network.

13. The method of claim 12, wherein the discovery condition comprises at least one of a first condition that a movement distance of the terminal after a first time at which the terminal discovered the first radio network is greater than a first threshold value, a second condition that a lapse time from the first time is greater than a second threshold value, and a third condition that movement speed of the terminal is lower than a third threshold value.

14. The method of claim 12, further comprising discovering the first radio network according to a second scan method among the plurality of network scan methods when the terminal is in a connected state and thus is connected to a second radio network,
wherein the discovering of the first radio network according to the first scan method further comprises storing the first information and the second information in a database, and
the discovering of the first radio network according to the second scan method comprises:
measuring the first information through the first RAT information while not accessing the first radio network; and
acquiring the second information using the first information from the database.

15. The method of claim 14, wherein the first information comprises an identifier of the first radio network, a frequency of the first radio network, and receiving power of the first radio network, and
the second information comprises a throughput of the first radio network, a packet loss rate of the first radio network, and a delay of the first radio network.

16. The method of claim 15, wherein the discovering of the first radio network according to the first scan method further comprises activating the first RAT interface when the discovery condition is satisfied before measuring the first information.

17. The method of claim 14, further comprising, when the terminal is in the connected state, discovering a third radio network which is a homogeneous network of the second radio network according to the second scan method,
wherein the storing in the data base comprises storing the first information and the second information in the database together with location information of the terminal,
wherein discovering of the third radio network according to the second scan method comprises acquiring QoS information of the third radio network from the database using the location information of the terminal,
wherein the second radio network and the third radio network correspond to a second RAT interface that is different from the first RAT interface.

18. The method of claim 14, wherein the discovering of the first radio network according to the second scan method further comprises setting a timer for periodic network discovery.

19. A terminal supporting a plurality of radio access technologies (RATs), comprising:
a memory; and
a processor connected with the memory and discovering a radio network,
wherein the processor selects at least one among a plurality of network scan methods based on a state of the terminal and discovers an accessible radio network according to the selected scan method.

20. The terminal of claim 19, wherein, when the terminal is in an idle state and a discovery condition is satisfied, the processor measures information on a first radio network according to a first scan method among the plurality of network scan methods and stores the information on the first radio network in a database,
the information on the first radio network comprises first information measured through a first RAT interface corresponding to the first radio network while the terminal is not accessing the first radio network and second information measured while accessing the first radio network, the second information being quality of service (QoS) information of the first radio network.
